(19) United States
(12) Patent Application Publication
(10) Pub. No.: US 2005/0247519 A1
(43) Pub. Date: Nov. 10, 2005

(54) Removable step for vehicle and method of use

(76) Inventor: Grant Richie Reid, Liberty Hill, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/841,251

(22) Filed: May 7, 2004

(51) Int. Cl. B62C 1/06

(52) U.S. Cl. 182/92

(57) ABSTRACT

A removable step for facilitating human access to a compartment of a vehicle may include a connector, an extender, and a stirrup. The connector may be coupled to a portion of the vehicle near a threshold of the vehicle. The extender may be flexible. In some embodiments, a flexible extender may be may be a strap. The extender may be coupled to the connector. The stirrup may be coupled to the extender. In some embodiments, an elongated member may be used to couple the stirrup to the extender. The connector may be designed to allow coupling to the vehicle and uncoupling from the vehicle with one hand. In some embodiments, the connector may be coupled to a bracket mounted to a vehicle.

### BACKGROUND

1. Field of Invention

The present invention generally relates to a device and a method to facilitate human access to a compartment of a vehicle. Embodiments of the invention relate to a removable step including a connector, an extender, and a stirrup.

2. Description of Related Art

U.S. Pat. No. 2,727,793 to Ricciuti, which is incorporated herein by reference, describes a step adapted to be removably attached to the side of a vehicle to facilitate reaching the upper surface of the top for cleaning. U.S. Pat. No. 4,605,098 to Leuty, which is incorporated herein by reference, describes a bumper step for enabling the user to conveniently access the engine compartment of a truck. U.S. Pat. No. Des. 296,887 to Walling et al., which is incorporated herein by reference, depicts an ornamental design for a vehicle tailgate step. U.S. Pat. No. 6,082,752 to Sumrall, which is incorporated herein by reference, describes a step assembly for mounting to a wheel well of a vehicle to permit a user to step up on the side of the vehicle.

U.S. Pat. No. 2,651,789 to Newland, which is incorporated herein by reference, describes a portable lifeline for attachment to boats. U.S. Pat. No. 2,975,858 to Billingsley, which is incorporated herein by reference, describes a boat stirrup for allowing a person to get out of the boat into the water or board the boat from the water. U.S. Pat. No. 5,848,667 to Davidson, which is incorporated herein by reference, describes a flexible and foldable marine ladder.

U.S. Pat. No. 277,389 to Weed, which is incorporated herein by reference, describes a tightly coiled steel wire attached to a stirrup or rest for the feet for use as a fire escape. U.S. Pat. No. 3,620,331 to Shaw, which is incorporated by reference herein, describes a horizontally movable suspension device for supporting a workman alongside the wall of a building or structure. U.S. Pat. No. 6,464,038 to Park, which is incorporated herein by reference, describes a footrest for rock climbing.

### SUMMARY

A removable step may be used to facilitate human access to the compartment of a vehicle. The removable step may include a connector, an extender, and a stirrup. The connector may be designed to couple to a portion of the vehicle near the compartment of the vehicle. The connector may be coupled to the extender. In some embodiments, the extender may be flexible. The extender may be coupled to the stirrup. The step may be designed such that a human foot, when positioned in the stirrup, may assume a range of angles with respect to a side of the vehicle.

A method of facilitating human access to the compartment of a vehicle may include coupling a first portion of a step to a portion of the vehicle near the compartment of the vehicle such that a second portion of the step extends below the body of the vehicle and is suspended above the surface on which the vehicle rests. A passenger may enter the compartment of the vehicle by placing a first foot in the second portion of the step and a second foot on the vehicle. The first portion of the step may be removed from the portion of the vehicle. In some embodiments, the step may be coupled to the vehicle or uncoupled from the vehicle with one hand.

### BRIEF DESCRIPTION OF THE DRAWINGS

Advantages of the present invention will become apparent to those skilled in the art with the benefit of the following detailed description and upon reference to the accompanying drawings in which:

FIG. 1 depicts a front view of an embodiment of a removable step.

FIG. 2 depicts a side view of an embodiment of a removable step.

FIG. 3 depicts a schematic view of a removable step coupled to a threshold of a vehicle.

FIG. 4 depicts a perspective view of an embodiment of a portion of a removable step with a mounting bracket.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

A removable step may be used to facilitate human access to a compartment of a vehicle. As used herein, “compartment” generally refers to a space for seating and/or for storage. As used herein, “vehicle” generally refers to a means of carrying or transporting one or more persons on land. Vehicles may include, but are not limited to, trucks, sport utility vehicles, off-the-road vehicles, four-wheel-drive vehicles, recreational vehicles, and elevated vehicles that may be difficult for a passenger to gain access to unaided. A removable step may be coupled to a portion of a vehicle (e.g., near a threshold of the vehicle, near a tail gate of a vehicle) to allow access to a compartment of the vehicle.

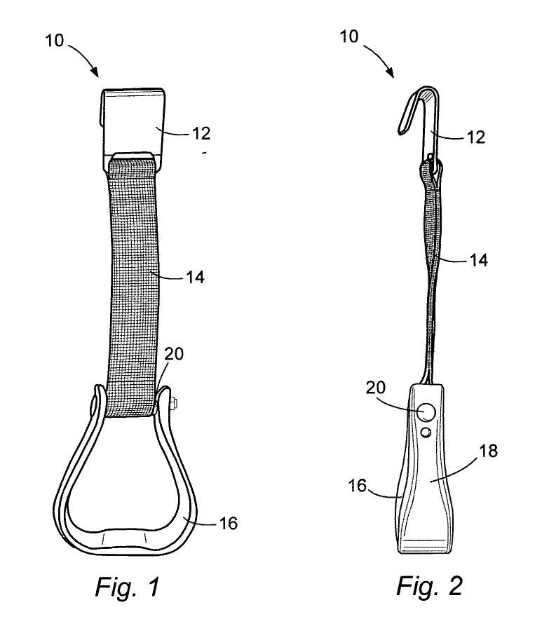

FIG. 1 depicts a front view of and embodiment of a removable step. Removable step 10 may include connector 12, extender 14, and stirrup 16. Connector 12 may be coupled to a first end of extender 14. As used herein, “coupled” members may be directly connected to each other or connected to each other with one or more intervening elements. “Reversibly coupled” members may be coupled and uncoupled as desired. “Irreversibly coupled” members may be considered to be permanently coupled. Extender 14 may be reversibly or irreversibly coupled to connector 12. Stirrup 16 may be reversibly or irreversibly coupled to a second end of extender 14. In an embodiment in which extender 14 is reversibly coupled to connector 12 and/or stirrup 16, a length of step 10 may be adjustable.

In some embodiments, connector 12 may be a unitary connector. Connector 12 may be formed of any material or combination of materials strong enough to support the weight of a person climbing into a vehicle. For example, connector 12 may be formed of any of a variety of metals and/or metal alloys. In some embodiments, connector 12 may be coated with a protective material (e.g., plastic or rubber) or powder coated to inhibit damage to (e.g., scratching of) the vehicle. A shape of connector 12 may allow the connector to couple to a portion of a vehicle near a threshold of the vehicle. A shape of at least a portion of connector 12 may be, but is not limited to, c-shaped, v-shaped, or u-shaped. For example, connector 12 may be a flat hook. In some embodiments, at least a portion of a connector may be bent to form a right angle. A width of connector 12 may range, for example, from about 5 cm (about 2 inches) to about 8 cm (about 3 inches). A width of connector 12 may be chosen to impart sufficient strength to step 10 while minimizing a cost of manufacturing the step and/or minimizing space required for use and/or storage of the step. In some embodiments, connector 12 may include one or more openings to allow coupling of extender 14 to the connector. In certain embodiments, connector 12 may couple to a bracket mounted on a vehicle.

In some embodiments, extender 14 may be flexible. In certain embodiments, extender 14 may be a strap. Extender 14 may be made of a material strong enough to support, for example, 20,000 lbs vertical load limit. For example, extender 14 may be a strap of nylon mesh. Stitching in extender 14 may meet guidelines generally known in the art (e.g., thread size, stitch size, stitching pattern) to support a desired amount of weight. In an embodiment, extender 14 may be a ratchet strap. In some embodiments, portions of extender 14 may be overlapped (e.g., the extender may be doubled) and secured together to provide extra strength to step 10. Extender 14 may be, for example, about 5 cm (about 2 inches) wide or about 8 cm (about 3 inches) wide. A length of extender 14 may be defined as the length of the extender after assembly of step 10. A length of extender 14 may range from, for example, about 5 cm (about 2 inches) to about 50 cm (about 20 inches). Extender 14 may be coupled to connector 12 in various ways. For example, an end of extender 14 may be inserted through an opening in connector 12, looped around a portion of the connector, and reversibly coupled (e.g., snapped) or irreversibly coupled (e.g., sewn, riveted) to a portion of the extender. In some embodiments, extender 14 may be threaded through two or more openings in connector 12 to achieve secure, reversible coupling of the extender to the connector in a manner generally known in the art.

A portion (e.g., an end) of extender 14 may be reversibly or irreversibly coupled to stirrup 16. As used herein, “stirrup” generally refers to a member with an opening for receiving a foot. A stirrup may be made of various materials including, but not limited to, wood, metal, plastic, or a combination thereof. In some embodiments, a portion of a stirrup made of one material may be reinforced with another material. For example, the side view of step 10 depicted in FIG. 2 depicts stirrup 16 with metal 18 wrapped around and riveted to an exterior of the stirrup. In some embodiments, wooden stirrup 16 may be reinforced with metal 18. In an embodiment, metal 18 may be sheet metal cut to a desired size and/or shape for use with stirrup 16. As show in FIG. 2, metal 18 may be fastened along a surface of stirrup 16 such that only wood is exposed along the edges of the stirrup, reducing damage (e.g., scratching) of a vehicle. Metal 18 may cover all or a portion of the interior and/or exterior of stirrup 16.

In an embodiment, a stirrup may be shaped and/or sized to accept a shoe of a certain style and/or size. A shape of a stirrup may be regular or irregular. A shape of a stirrup may include, but is not limited to, round, triangular, rectangular, square, or u-shaped. In certain embodiments, a stirrup may have one or more curved portions (e.g., curved side portions). In some embodiments, a stirrup with curved portions may have an oxbow shape. A stirrup with curved portions may provide a better fit for a shoe of a user and/or more secure footing for a user that a stirrup with straight portions (e.g., sides). A stirrup with curved portions may promote ease of insertion of a foot in a stirrup and/or removal of a foot from a stirrup. A stirrup with curved portions may promote safety during insertion of a foot in a stirrup and removal of a foot from a stirrup by reducing a probability of a shoe (e.g., boot) becoming lodged or stuck in the stirrup. A stirrup with curved and/or rounded portions may also reduce a chance of the vehicle becoming damaged (scratched) by a corner (e.g., angle) of a stirrup. In some embodiments, a stirrup may have a substantially straight bottom portion and one or more curved side portions, as shown in FIG. 1.

In an embodiment, portions of a stirrup may vary in width and/or thickness. In some embodiments, a bottom portion (e.g., footrest portion) of a stirrup may be thicker than a side portion of the stirrup to provide comfort and/or support for a user's foot. In some embodiments, side portions of a stirrup near the extender may have a greater thickness and/or smaller width than side portions of the stirrup near the footrest of the stirrup. In some embodiments, a stirrup may be designed to resemble a shape of stirrup associated with a western style horse saddle (as depicted in FIGS. 1 and 2) or an English style horse saddle. In certain embodiments, a stirrup may be any commercially available stirrup (e.g., bell bottom stirrup, barrel racer stirrup).

As shown in FIG. 1, extender 14 may be coupled to elongated member 20 inserted through sides of stirrup 16. In some embodiments, elongated member 20 may be a bolt, as depicted in the side view of step 10 shown in FIG. 2. Extender 14 may be coupled to stirrup 16 with elongated member 20 such that the stirrup may pivot with respect to the extender. For example, an end of extender 14 may be looped around a portion of connector 12 and reversibly coupled (e.g., snapped) or irreversibly coupled (e.g., sewn, riveted) to a portion of the extender. In some embodiments, an end of extender 14 looped through connector 12 and an end of the extender looped around elongated member 20 meet or overlap along a portion of the extender. Ends of extender 14 that meet or overlap may be reversibly or irreversibly coupled to portions of the extender.

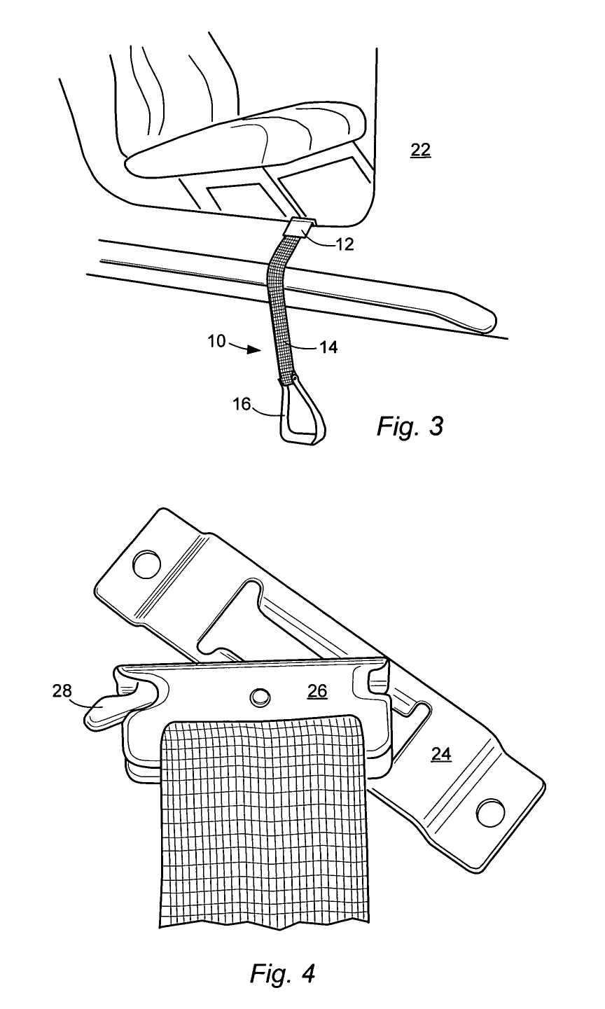

A step may be used to facilitate human access to a compartment of a vehicle. A user may couple a connector of the step to a portion of a vehicle near the compartment of the vehicle. FIG. 3 depicts a perspective view of step 10 coupled to a threshold of vehicle 22. In some embodiments, a user may couple connector 12 of step 10 to a portion of vehicle 22 using one hand.

In an embodiment, connector 12 of step 10 may be coupled to a bracket mounted on a vehicle. FIG. 4 depicts bracket 24 designed to accept connector 12. Bracket 24 may be, for example, E-Track (available from, e.g., Northern Tool & Equipment Co., Burnsville, Minn.). In some embodiments, bracket 24 may be bolted to a vehicle near a compartment of the vehicle. For example, bracket 24 may be bolted on or near a tailgate of a truck. Connector 26 may be coupled to bracket 24. In some embodiments, connector 26 may be hooked over a portion of bracket 24. In certain embodiments, connector 26 may be slid into a portion of bracket 24. In some embodiments, connector 26 may include mechanism 28 to engage bracket 24. Mechanism 28 may lock connector 26 to bracket 24. In certain embodiments, mechanism 28 may be spring-loaded. In certain embodiments, mechanism 28 may be a quick connect. In an embodiment, connector 26 may be an E-Track connector.

After a connector of a removable step is coupled to a vehicle, a stirrup of the step may extend below the body of the vehicle. The step may be suspended above the surface on which the vehicle rests. The user may place a first foot in the stirrup. The step may be designed such that a foot placed in the opening of the stirrup is substantially perpendicular to a side of the vehicle. A flexible extender may allow an angle of the user's foot relative to the side of the vehicle to vary during use. For example, a user may insert a foot in the stirrup such that the foot is substantially perpendicular to the side of the vehicle, then turn such that the foot is at an angle less than 90° (e.g., 45°, 30°, 15°) with respect to the side of the vehicle or substantially parallel to the side of the vehicle. In some embodiments, a user may rotate a stirrup of a step with respect to the vehicle before the user's foot is inserted in the stirrup or before a user's full weight is applied to the stirrup.

The user may place a second foot on or in the vehicle (e.g., near the threshold of the vehicle). A flexible strap may promote ease and/or comfort associated with climbing into the vehicle by accommodating natural movement of the body from the ground into the vehicle. After entering or boarding the compartment of the vehicle, the user may remove the step from the portion of the vehicle. In some embodiments, a user may remove the step from the vehicle with one hand. The step may be stored in the vehicle (e.g., in the compartment of the vehicle) after use. A flexible extender may allow compact storage of a step in a vehicle.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described-herein without departing from the spirit and scope of the invention as described in the following claims.

1. A removable step to facilitate human access to a compartment of a vehicle, comprising:
a connector configured to couple to a portion of the vehicle near the compartment of the vehicle;
a flexible extender coupled to the connector;
a stirrup coupled to the extender; and
wherein the step is configured such that a human foot, when positioned in the stirrup during use, assumes a range of angles with respect to a side of the vehicle during use.

2. (canceled)

3. (canceled)

4. The step of claim 1, wherein the connector is unitary.

5. The step of claim 1, further comprising a bracket configured to be mounted on the vehicle, wherein the connector comprises a mechanism configured to engage the bracket.

6-11. (canceled)

12. The step of claim 1, wherein ends of the extender meet along a portion of the extender and are secured to the extender.

13. The step of claim 1, wherein ends of the extender overlap along a portion of the extender and are secured to the extender.

14. The step of claim 1, wherein a length of the extender is adjustable.

15-21. (canceled)

22. The step of claim 1, further comprising an elongated member configured to couple the extender to the stirrup.

23. The step of claim 1, wherein the extender is coupled to the stirrup such that the angle between the stirrup and the extender varies during use.

24. (canceled)

25. The step of claim 1, wherein the step is configured such that the stirrup is vertically suspended between the body of the vehicle and the surface on which the vehicle rests during use.

26. A method of facilitating human access to a compartment of a vehicle, comprising:
coupling a first portion of a step to a portion of the vehicle near the compartment of the vehicle such that a second portion of the step extends below the body of the vehicle and is suspended above the surface on which the vehicle rests;
allowing a passenger to enter the compartment of the vehicle by placing a first foot in the second portion of the step and a second foot on the vehicle; and
removing the first portion of the step from the portion of the vehicle.

27. The method of claim 26, further comprising allowing the first foot of the passenger to assume a range of angles with respect to a side of the vehicle.

28. The method of claim 26, wherein coupling the first portion of the step to the portion of the vehicle comprises hooking the first portion of the step over the portion of the vehicle.

29. The method of claim 26, wherein coupling the first portion of the step to the portion of the vehicle comprises coupling the first portion of the step to a bracket mounted on the vehicle.

30. The method of claim 26, wherein coupling the first portion of the step to the portion of the vehicle comprises hooking the first portion of the step over the portion of the vehicle with one hand.

31. The method of claim 26, wherein removing the first portion of the step from the portion of the vehicle comprises uncoupling the first portion of the step from the portion of the vehicle with one hand.

32. (canceled)

33. A method of entering a compartment of a vehicle, comprising:
coupling a first portion of a step to a portion of the vehicle near a compartment of the vehicle such that a second portion of the step extends below the body of the vehicle and is suspended above the surface on which the vehicle rests;
placing a first foot in the second portion of the step and a second foot on the vehicle; and
removing the first portion of the step from the portion of the vehicle while inside the vehicle.

34. (canceled)

35. (canceled)

36. The method of claim 33, wherein coupling the first portion of the step to the portion of the vehicle comprises hooking the first portion of the step over the portion of the vehicle.

37. The method of claim 33, wherein coupling the first portion of the step to the portion of the vehicle comprises coupling the first portion of the step to a bracket mounted on the vehicle.

38. The method of claim 33, wherein coupling the first portion of the step to the portion of the vehicle comprises hooking the first portion of the step over the portion of the vehicle with one hand.

39. The method of claim 33, wherein removing the first portion of the step from the portion of the vehicle comprises uncoupling the first portion of the step from the portion of the vehicle with one hand.

40. (canceled)
